(19) United States
(12) Patent Application Publication
(10) Pub. No.: US 2024/0230312 A1
(43) Pub. Date: Jul. 11, 2024

(54) OPTICAL MEASUREMENT APPARATUS AND METHOD OF RAPID MEASUREMENT

(71) Applicant: Occuity Limited, London (GB)

(72) Inventor: James REYNOLDS, Gloucestershire (GB)

(73) Assignee: Occuity Limited, London (GB)

(21) Appl. No.: 18/563,811

(22) PCT Filed: May 16, 2022
(86) PCT No.: PCT/EP2022/063186

§ 371 Date: Nov. 22, 2023

(30) Foreign Application Priority Data
May 26, 2021 (GB) 2107471.1

(51) Int. Cl. G01B 9/02015; G01B 9/02; G01B 9/0209; G01B 11/06; G01N 21/45

(52) U.S. Cl. CPC G01B 9/0203; G01B 9/02042; G01B 9/0209; G01B 11/06; G01N 21/45

(57) ABSTRACT

An optical measurement apparatus (100) combines confocal measurement and low coherence interferometric measurement. The apparatus (100) comprises a confocal measurement subsystem (102) and an interferometric measurement subsystem (104) disposed within a housing (138). An optical combiner (126) is configured to provide the confocal measurement subsystem (102) and the interferometric measurement subsystem (104) with irradiative access to a region to be measured (134) located at a substantially static target location. An optical path internal to the housing (138) extends from the optical combiner (126) towards the region to be measured (134), and the internal optical path is common to the confocal measurement subsystem (102) and the interferometric measurement subsystem (104). The confocal measurement subsystem (102) and the interferometric measurement subsystem (104) are configured to image longitudinally. and a length of the internal optical path is fixed.

The present invention relates to an optical measurement apparatus of the type that, for example, measures thickness and refractive index of a region to be measured located at a substantially static target location. The present invention also relates to a method of rapidly measuring, the method being of the type that, for example, measures a thickness and refractive index of a region to be measured located at a substantially static target location.

In the field of optical metrology, it is desirable to measure a thickness of a region of a material under investigation, for example biological tissue. It is further desirable, for some applications, to make measurements using a hand-held device. A number of measurement techniques exists to enable measurement of the thickness of a sample, for example techniques employing low-coherence interferometry or confocal optics. Both confocal optics and low coherence interferometry can be employed separately to measure thickness, for example as described in UK patent no. 2 451 442, and as is described in “Optical fibre Fizeau-based OCT” (Casaubieilh et al., Proceedings of SPIE: Second European Workshop on Optical Fibre Sensors: 9-11 Jun. 2004, Santander, Spain, pages 338 to 341), respectively.

Both techniques are capable of measuring either thickness or refractive index. However, in order to measure one of thickness or refractive index using one of these techniques, knowledge of the other parameter is required. For example, in order to be able to measure thickness, an estimate of the refractive index of the material is required. Furthermore, each of the above techniques uses a different measure of refractive index: low-coherence interferometry measurements are in the context of a group refractive index, whereas confocal optics measurements are in the context of a so-called phase refractive index. A disconnect therefore existing between these measures of refractive index.

Nevertheless, for some applications, it is desirable to measure both thickness and refractive index as both parameters provide useful diagnostic information. Prima facie, combining confocal optics with low-coherence interferometry would appear a route to calculating both the thickness and refractive index.

In this regard, it is known to combine confocal imaging systems with interferometric imaging systems, particularly Optical Coherence Tomography (OCT) systems, for example as described in: “Combined reflectance confocal microscopy-optical coherence tomography for delineation of basal cell carcinoma margins: an ex vivo study” (Iftimia et al., Journal of Biomedical Optics, Jan. 2016, Vol. 21(1), pages 016006-1 to 016006-7), “Combined reflection confocal microscopy and optical tomography imaging of esophageal biopsy” (Kang et al., Gastrointestinal Endoscopy, Volume 69, Issue 5, 2009, AB368), and “Optical coherence tomography combined with confocal microscopy for investigation of interfaces in class V cavities” (Rominu et al., Proceedings of SPIE-OSA Biomedical Optics, SPIE Vol. 7372, pages 737228-1 to 737228-6).

However, the arrangements described in these documents employ confocal optics for lateral imaging and low-coherence interferometry (OCT) for longitudinal imaging rather than measuring thickness and refractive index. In this regard, the authors of these documents do not seek to measure both thickness and refractive index and so are not concerned with addressing measurement of both at the same time. Instead, the thickness is measured indirectly from an estimate of refractive index and moreover each technique relies upon a different measure of refractive index.

In contrast, “Characterizing refractive index and thickness of biological tissues using combined multiphoton microscopy and optical coherence tomography” (Zhou et al., Biomed Optical Express, 1 Jan. 2013, Vol. 4, No. 1, pages 38 to 50) describes characterisation of a refractive index and thickness distribution in biological tissue by combining multiphoton microscopy (MPM) and optical coherence tomography (OCT) systems. However, arrangements of this type are typically quite complex and do not lend themselves well for use in portable devices owing to the need to use a femtosecond laser. This technique also requires the presence of fluorophores for twin-photon excitation and/or non-spherosymmetric molecules for second harmonic generation, thereby limiting the range of target materials with which this technique can be employed. Additionally, output signals from each of these techniques are small and so require the use of photomultiplier tubes. Furthermore, in relation to certain in vivo applications, for example an eye, use of a femtosecond laser may not be safe owing to the need to generate a very high peak power to obtain a measurable signal using either of the above techniques.

Korean patent publication KR20090078296 also relates to measurement of refractive index and thickness by combining low-coherence interferometry and confocal optics. However, in order to address the disconnect between the phase refractive index and the group refractive index mentioned above, the techniques described in this publication calculate a measure of dispersion linking the phase refractive index with the group refractive index. The apparatus described therein employs a confocal optical system and an adjustment mechanism to adjust an optical path length between a beamsplitter and a sample under investigation in order to maximise an incoherent confocal signal prior to making an interferometric measurement. Measurements are made at multiple wavelengths in order to determine the dispersion, which is used to determine phase and group refractive indices, thereby enabling the thickness to be calculated. This adds complexity to the process of making combined confocal and low-coherence interferometric measurements. Furthermore, although this document refers to “simultaneous” measurements being made, it is not in the temporal sense and refers to a single optical system capable of making all the measurements required over time in order to determine the thickness and refractive indices. As such, the apparatus described in KR 20090078296 is unable to measure substantially contemporaneously a sample in a single measurement step in order to determine the thickness and refractive index of the sample.

According to a first aspect of the present invention, there is provided an optical measurement apparatus combining confocal measurement and low-coherence interferometric measurement, the apparatus comprising: a housing; a confocal measurement subsystem disposed within the housing; an interferometric measurement subsystem disposed within the housing; an optical combiner configured to provide the confocal measurement subsystem and the interferometric measurement subsystem with irradiative access to a region to be measured located at a substantially static target location; and an optical path internal to the housing, the optical path extending from the optical combiner towards the region to be measured, the internal optical path being common to the confocal measurement subsystem and the interferometric measurement subsystem; wherein the confocal measurement subsystem is configured to image longitudinally; the interferometric measurement subsystem is configured to image longitudinally; and a length of the internal optical path is fixed.

The apparatus may further comprise: a measurement controller operably coupled to the confocal measurement subsystem and the interferometric measurement system; wherein the measurement controller may be further configured to perform, when in use, a confocal measurement and an interferometric measurement substantially contemporaneously over a measurement cycle.

The interferometric measurement subsystem may be substantially optically uninfluenced, when in use, by operation of the confocal measurement.

The confocal measurement subsystem may comprise at least one longitudinal imaging component; the interferometric measurement subsystem may comprise a measurement branch and a reference branch; and neither the measurement branch nor the reference branch of the interferometric measurement subsystem may comprise the at least one longitudinal imaging component.

The length of the internal optical path may not be adjusted. The length of the internal optical path may be physically fixed. The length of the internal optical path may not be configured.

The length of the internal optical path may be unchanged over the measurement cycle.

The confocal measurement subsystem may be operationally independent of the interferometric measurement subsystem.

Operation of the confocal measurement subsystem may not influence a measurement result generated, when in use, by the interferometric measurement subsystem.

The confocal measurement subsystem may comprise a translatable optical element; the translatable optical element may not serve as a bias in the interferometric measurement subsystem. The translatable optical element may not influence a measurement result generated, when in use, by the interferometric measurement subsystem. The internal optical path may not comprise the translatable optical element.

The apparatus may further comprise the confocal measurement subsystem operably coupled to the interferometric measurement subsystem.

The apparatus may further comprise a source of at least partially coherent electromagnetic radiation. The source of the at least partially coherent electromagnetic radiation may be a common source of electromagnetic radiation operably shared by the confocal measurement subsystem and the interferometric measurement subsystem.

The confocal measurement subsystem and the interferometric subsystem may be configured to use a source of electromagnetic radiation of a same wavelength.

The optical combiner may be configured to return more light towards the confocal measurement subsystem than the interferometric measurement subsystem.

The confocal measurement subsystem may comprise a first translatable optical element and the interferometric measurement subsystem may comprise a second translatable optical element; the first and second optical elements may be configured to be translated substantially contemporaneously.

The first and second optical elements may be carried by a common translatable assembly.

The first optical element may be a lens. The second optical element may be a reference mirror.

The interferometric measurement subsystem may be a low-coherence interferometric measurement subsystem.

The apparatus may further comprise a lookup table comprising a plurality of confocal measurement error correction values.

In accordance with a second aspect of the present invention, there is provided a calibration system comprising the optical measurement apparatus as set forth above in relation to the first aspect of the invention, the system further comprising: a translatable calibration target disposed opposite a measurement port of the optical measurement apparatus and incrementally translatable relative to the optical measurement apparatus; wherein the confocal measurement subsystem is configured to measure a first distance to the calibration target and the confocal measurement subsystem is configured to measure a second distance to the calibration target; and the processing resource is configured to calculate an error correction value using the first and second measured distances.

The translatable calibration target may be translatable by predetermined distance increments.

The processing resource may be configured to generate a lookup table comprising the error correction value.

According to a third aspect of the present invention, there is provided a method of rapidly measuring a refractive index and a thickness of a region to be measured located at a substantially static target location, the method comprising: longitudinally imaging using a confocal measurement subsystem of an optical measurement apparatus to make a first measurement; substantially contemporaneously longitudinally imaging using an interferometric measurement subsystem of the optical measurement apparatus to make a second measurement; and calculating a thickness and a refractive index using the first and second measurements.

The method may further comprise: solving a system of equations using the first and second measurements by neglecting a dispersion of electromagnetic radiation or assuming a constant dependent upon the dispersion of the electromagnetic radiation.

The method may further comprise making the first measurement by translating a first optical element and detecting a first peak received signal and a second peak received signal and calculating a first translation distance of the first optical element between the detection of the first peak received signal and the second peak received signal; the method may further comprise making the second measurement by translating a second optical element and detecting a third peak received signal and a fourth peak received signal and calculating a second translation distance of the second optical element between the detection of the third peak received signal and the fourth peak received signal.

It is thus possible to provide an optical measurement apparatus and a method of measuring a refractive index that can, in a single measurement step, measure specular reflection of light from front and back surfaces of a sample under test in order to enable both refractive index and thickness of the sample to be determined. Furthermore, the structure of the apparatus is compatible with implementation in a hand-held device as well as being safe for in vivo measurements. Additionally, the performance of both the interferometric and confocal measurements within the same measurement cycle is sufficiently fast to be affected by movement of the target location, which remains substantially static during the very short measurement cycle.

At least one embodiment of the invention will now be described, by way of example only, with reference to the accompanying drawings, in which:

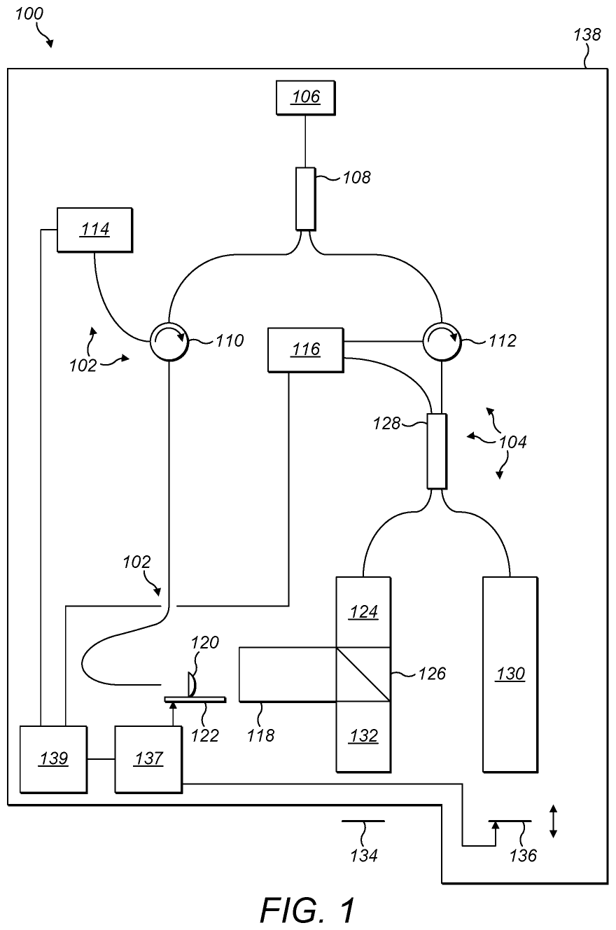

FIG. 1 is schematic diagram of an optical measurement apparatus in overview constituting an embodiment of the invention;

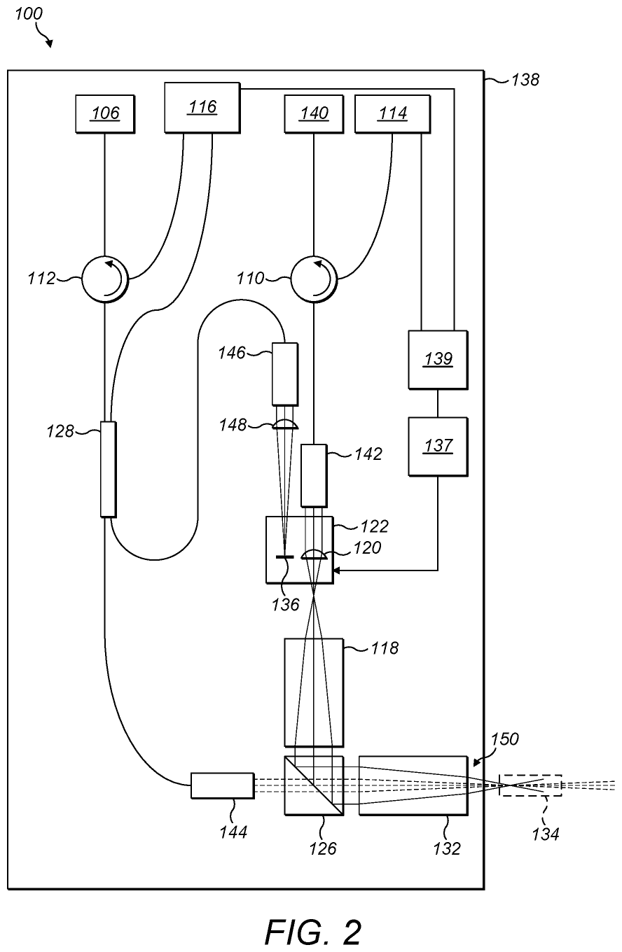

FIG. 2 is a schematic diagram of the apparatus of FIG. 1 in greater detail;

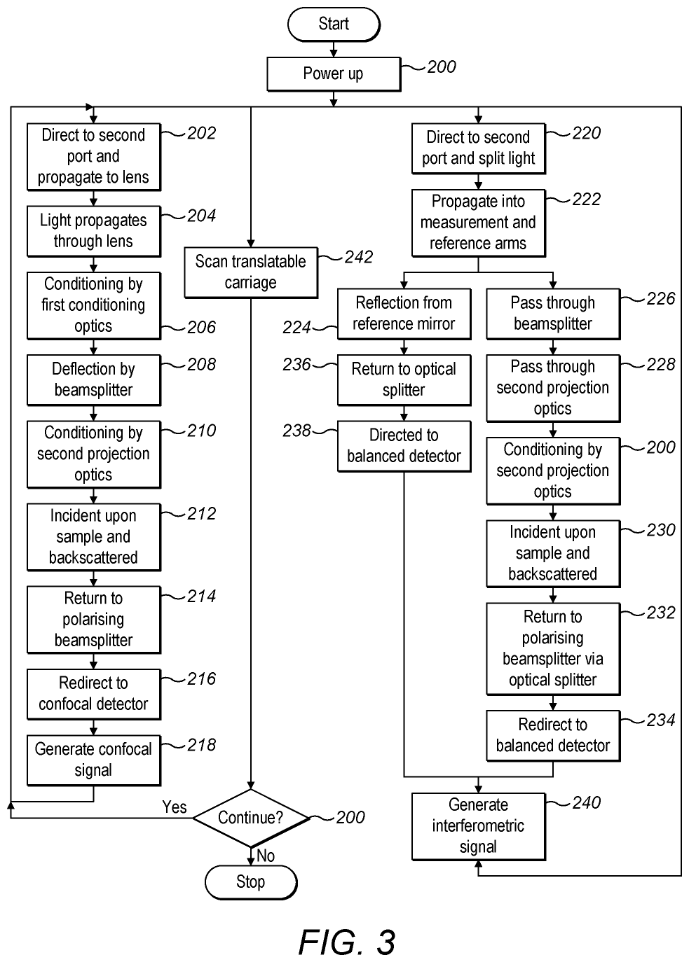

FIG. 3 is a flow diagram of a method of measuring a refractive index and a thickness used by the apparatus of FIGS. 1 and 2; and

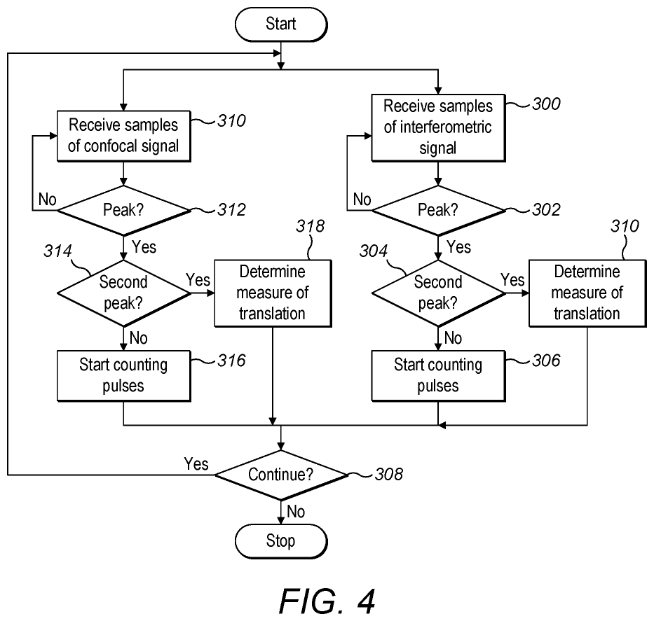

FIG. 4 is a flow diagram of a method of calculating translation of a translatable carriage of FIG. 1.

Throughout the following description identical reference numerals will be used to identify like parts.

Referring to FIG. 1, in overview, an optical measurement apparatus 100 combines a confocal measurement subsystem 102 with a low-coherence interferometric measurement subsystem 104. The apparatus 100 comprises a source of at least partially coherent electromagnetic radiation, for example a Superluminescent Light Emitting Diode (SLED) 106, operably coupled to an input of a first optical splitter 108. In this regard, to emit at least partially coherent electromagnetic radiation, the source of electromagnetic radiation has a continuous spectrum and a bandwidth between about 1% and about 10% of a centre wavelength of the electromagnetic radiation emitted. A first output of the first optical splitter 108 is operably coupled to a first port of a first optical circulator 110, and the second output of the first optical splitter 108 is operably coupled to a first port of a second optical circulator 112. The first optical circulator 110 permits electromagnetic radiation to pass through to a second port thereof and the second optical circulator 112 permits electromagnetic radiation to pass through to a second port thereof.

The second port of the first optical circulator 110 is operably coupled to a confocal detector unit 114. The confocal detector unit 114 can be any suitable arrangement of optical and optoelectronic devices, for example a fibre-optic implementation, employing a pigtailed photodiode, of the arrangement described in UK patent no. 2 508 368. As the exact implementation of the confocal detector unit 114 is not core to an understanding of the operation of the embodiments described herein, the confocal detector unit 114 will not be described in any further detail.

Similarly, the second port of the second optical circulator 112 is operably coupled to a first port of a balanced detector unit 116. The balanced detector unit 116 can be any suitable arrangement of optical and optoelectronic devices, for example as described in “Balanced detection technique to measure small changes in transmission” (Houser et al., Applied Optics, 33 1059-1062 (1994)), and as the exact implementation of the balanced detector unit 116 is not core to an understanding of the operation of the embodiments described herein, the balanced detector unit 116 will not be described in any further detail. However, the skilled person should appreciate that other kinds of detector can be employed instead of the balanced detector unit 116, for example a photodiode detector or an avalanche photodiode (APD).

A third port of the first optical circulator 110 is guided to, typically with collimation (not shown), an optical element, such as a lens 120, mounted on a linearly translatable carriage 122, the lens being disposed opposite a first port of a first projection optics unit 118. A second port of the first projection optics unit 118 is operably coupled to a measurement arm or branch 124 of the low-coherence interferometric measurement subsystem 104 via a polarising beamsplitter 126 constituting an optical combiner. The beamsplitter 126 serves to provide the confocal measurement subsystem 102 and the interferometric measurement subsystem 104 with irradiative access to a sample 134 described in further detail later below. Furthermore, the use of the polarising beamsplitter 126 optimises the return of light reflected by the sample 134 to the confocal measurement subsystem 102 and the low-coherence interferometric measurement subsystem 104, but particularly the confocal measurement subsystem 102.

In this example, the optical combiner is a polarising beamsplitter, but in another embodiment the beamsplitter can be non-polarising and configured to provide an unequal power splitting ratio in order to return more light towards the confocal measurement subsystem 102 than the interferometric measurement subsystem 104, more specifically more of the light to the parts of the confocal measurement subsystem 102 upstream of the optical combiner towards the first optical circulator 110 than the parts of the low-coherence interferometric measurement subsystem 104 upstream of the optical combiner towards the second optical circulator 112.

A second port of the balanced detector unit 116 is operably coupled to a first port of a second optical splitter 128, and a third port of the second optical circulator 112 is operably coupled to a second port of the second optical splitter 128. A third port of the second optical splitter 128 is operably coupled to the measurement arm 124, and a fourth port of the second optical splitter 128 is operably coupled to a reference arm or branch 130.

A second projection optics unit 132, constituting a common sub-arm 132, is operably coupled to the beamsplitter 126 and provides an internal optical path for both the measurement arm 124 and the first projection optics unit 118, i.e. the internal optical path is common to the confocal measurement subsystem 102 and the interferometric measurement subsystem 104. Furthermore, the internal optical path is internal to a housing 138 described later herein and extends from the beamsplitter 126 towards the sample 134. In this example, the length of the internal optical path is fixed. The sample 134, for example biological tissue, which can be in vivo or in vitro, is disposed opposite the second projection optics unit 132 and a reference mirror 136 is, in this example, disposed opposite the reference arm 130 and can linearly translate so as to move closer to and farther away from the reference arm 130. In this example, both the lens 120 and the reference mirror 136 are configured to be translated substantially contemporaneously when in use. A processing resource, for example a translation controller 137, such as a microcontroller, is operably coupled to the translatable carriage 122 and the reference mirror 136 via another translation mechanism (not shown), although it should be appreciated that both the lens 120 and the reference mirror 136 can be carried and translated by the single translatable carriage 122 under the control of the translation controller 137. Assuming a single translatable carriage 122 for the sake of conciseness and simplicity of description, the translatable carriage 122 carries an encoder scale and a linear encoder is disposed opposite the encoder scale and operably coupled to the translation controller 137. The combination of the linear encoder and the encoder scale is, for example, of the type described in UK patent no. GB 2 467 340, and serves to provide position feedback, when in use, with respect to the translatable carriage 122. Of course, if more than one translatable carriage is employed, then a corresponding greater number of encoder scales and linear encoders can be employed to obtain position feedback in respect of each translatable carriage. The processing resource also supports a measurement unit 139 is operably coupled to the translation controller 137 as well as the confocal detector unit 114 of the confocal measurement subsystem 102 and the balanced detector unit 116 of the low-coherence interferometric measurement subsystem 104.

As will be apparent to the person skilled in the art, the first optical circulator 110, the confocal detector unit 114 and the first projection optics unit 118 constitute the confocal measurement subsystem 102. Similarly, the second optical circulator 112, the balanced detector unit 116, the measurement arm 124, the reference arm 130 and the reference mirror 136 constitute the low-coherence interferometric measurement subsystem 104.

The above optical measurement apparatus 100 comprises a housing 138 within which the confocal measurement subsystem 102 and the low-coherence interferometric measurement subsystem 104 are disposed along with, in this example, the SLED 106 and the first optical splitter 108.

Turning to FIG. 2, in this example, the source of electromagnetic radiation is separated into two independent light sources. The SLED 106 is employed in relation to the low-coherence interferometry subsystem 104 and a laser diode (LD) 140 is provided in relation to the confocal measurement subsystem 102.

As in the previous example, the optical measurement apparatus 100 comprises the housing 138 within which the confocal measurement subsystem 102 and the low-coherence interferometric measurement subsystem 104 are disposed along with, in this example, the SLED 106, the laser diode 140, the translation controller 137, the measurement unit 139, the encoder scale and the linear encoder.

The laser diode 140 is operably coupled to the first port of the first optical circulator 110 by optical fibre, and the SLED 106 is operably coupled to the first port of the second optical circulator 112 by optical fibre. The second port of the first optical circulator 110 is operably coupled to the confocal detector unit 114 by optical fibre. The confocal detector unit 114 can be any suitable arrangement of optical and optoelectronic devices as mentioned above in relation to the previous example.

Likewise, the second port of the second optical circulator 112 is operably coupled to the first port of the balanced detector unit 116 by optical fibre. The balanced detector unit 116 can be any suitable arrangement of optical and optoelectronic devices, as mentioned above in relation to the previous example.

The third port of the first optical circulator 110 is operably coupled to a first fibre collimator 142 by optical fibre and is disposed opposite a first side of the translatable carriage 122 carrying, in this example, the optical element, which is a first of two optical elements described in relation to this example, such as the lens 120 and the reference mirror 136. The translatable carriage 122 therefore constitutes a common translatable assembly. Although one translatable lens is described in the examples herein, the skilled person should appreciate that at least one optical element can be employed.

The translatable carriage 122 is operably coupled to the translation controller 137 and the linear encoder (not shown), the translation controller 137 being operably coupled to the measurement unit 139. In this example, the measurement unit 139 is operably coupled to the confocal detector unit 114 and the balanced detector unit 116.

The first port of the first projection optics unit 118 is also disposed opposite the translatable carriage 122 at a second side thereof and aligned with the lens 120. The second port of the first projection optics unit 118 is operably coupled to the measurement arm 124 of the low-coherence interferometric measurement subsystem 104 via a first port of the beamsplitter 126 constituting the optical combiner. The beamsplitter 126 serves to provide the confocal measurement subsystem 102 and the interferometric measurement subsystem 104 with irradiative access to a sample 134 described in further detail later below. Furthermore, the use of the polarising beamsplitter 126 optimises the return of light reflected by the sample 134 to the confocal measurement subsystem 102 and the low-coherence interferometric measurement subsystem 104, but particularly the confocal measurement subsystem 102.

The second port of the balanced detector unit 116 is operably coupled to the first port of the optical splitter 128 by optical fibre, the third port of the second optical circulator 112 being operably coupled to the second port of the optical splitter 128 by optical fibre. The third port of the second optical splitter 128 is operably coupled to a second fibre collimator 144 by optical fibre, the second fibre collimator 144 being disposed opposite a second port of the beamsplitter 126 and forming part of the measurement arm 124 mentioned in the previous example. The fourth port of the second optical splitter 128 is operably coupled to a third fibre collimator 146 by optical fibre, the third fibre collimator 146 also being disposed opposite the translatable carriage 122 at the first side thereof, the third fibre collimator 146 being aligned with the reference mirror 136. A second optical element, for example a focussing optical element, such as a lens 148, is disposed between the third fibre collimator 146 and the translatable reference mirror 136. In another example, the lens 148 can be disposed on the translatable carriage 122 so as to translate with the translatable carriage 122. In this example, the third fibre collimator 146, the lens 148 and the reference mirror 136 constitute the reference arm 130. The skilled person should appreciate though that other implementations are conceivable, for example the third fibre collimator 146 and the lens 148 can be incorporated into the optical fibre coupled to the third fibre collimator 146 by way of providing a lensed fibre.

The second projection optics unit 132, constituting the common sub-arm, is operably coupled to a third port of the beamsplitter 126 and provides the internal optical path for both the measurement arm 124 and the first projection optics unit 118 mentioned above in relation to the previous example, thereby enabling the confocal measurement subsystem 102 operably coupled to the low-coherence interferometric measurement subsystem 104 to address the same region to be measured. In this example, the length of the internal optical path is fixed and cannot be adjusted or configured by either of the measurement subsystems 102, 104.

Indeed, the length of the internal optical path can be physically fixed. The sample 134, for example the biological tissue, which can be in vivo or in vitro, is disposed opposite the second projection optics unit 132 and lies within the region to be measured, the sample being, in this example substantially static during a measurement cycle, for example the apparatus 100 is not provided with a mechanism to move the sample 134 relative to the housing 138 and hence the second projection optics unit 132. The shared use of the internal optical path, configured as set forth above, supports the provision of separate interferometric and confocal channels that can share the common sub-arm mentioned above substantially contemporaneously and without the confocal channel influencing or perturbing the interferometric channel and vice versa. In this regard, both the confocal measurement subsystem 102 and the low-coherence interferometric measurement subsystem 104 address the same target, for example the sample 134, at the same time.

As will be apparent to the person skilled in the art, the first optical circulator 110, the confocal detector unit 114, the laser diode 140, the first fibre collimator 142, the lens 143 and the first projection optics unit 118 constitute the confocal measurement subsystem 102. Similarly, the second optical circulator 112, the SLED 106, the balanced detector unit 116, the optical splitter 128, the measurement arm 124, the reference arm 130, the reference mirror 136 and the second and third fibre collimators 144, 146 constitute the low-coherence interferometric measurement subsystem 104.

In operation (FIG. 3), the laser diode 140 and the SLED 106 are both powered up (Step 200) and first electromagnetic radiation, for example coherent first electromagnetic radiation (hereafter referred to as “first light”) is emitted by the laser diode 140, and second electromagnetic radiation, for example at least partially coherent second electromagnetic radiation (hereafter referred to as “second light”) is emitted by the SLED 106.

Referring to the confocal measurement subsystem 102, the first light emitted by the laser diode 140 propagates to the first optical circulator 110 and is directed (Step 202) by the first optical circulator 110 to the second port thereof before propagating to the first fibre collimator 142 where the first light is collimated. The collimated first light is incident upon the lens 120 (Step 202), which focusses (Step 204) the light prior to entering the first projection optics unit 118. The focussed first light propagates through the first projection optics unit 118 and is condition (Step 206) by the optical elements contained therein before then being incident upon the beamsplitter 126 where the focussed first light is redirected (Step 208) by the beamsplitter 126 to the second projection optics unit 132.

The focused first light then propagates through the second projection optics unit 132 and is condition (Step 210) by the optical elements contained therein before being focussed (Step 212) onto a point within or on the sample 134. The focussed light focussed on the sample 134 is specularly reflected (Step 212) and some of the reflected first light returns (Step 214) to the second projection optics unit 132, whereupon the reflected first light propagates through the second projection optics unit 132 and is redirected by the beamsplitter 126 towards the first projection optics unit 118. Thereafter, the returning reflected light propagates through the first projection optics unit 118 and then propagates through the lens 120 before entering the first fibre collimator 142 and propagating back (Step 214) to the first optical circulator 110. At the first optical circulator 110, the returning reflected first light is directed (Step 216) by the first optical circulator 110 to the confocal detector unit 114. The first optical circulator 110 serves to direct light received thereby to the third port thereof and thus to the confocal detector unit 114.

The confocal detector unit 114 receiving the returning reflected first light generates (Step 218) a confocal detection signal. The confocal detection signal is analysed in a manner described later herein.

Turning to the low-coherence interferometric subsystem 104, the second light emitted by the laser diode 140 is directed (Step 220) by the second optical circulator 112 to the second port thereof before propagating to the optical splitter 128. The second light is then split (Step 220) by the optical splitter 128 and a first portion of the second light propagates (Step 222) to the second fibre collimator 144 and a second portion of the second light propagates (Step 222) to the third fibre collimator 146, where the first and second portions of the second light are respectively collimated.

At the second fibre collimator 144, the first portion of the second light propagates through the lens 148 and is focussed on the reference mirror 136 before being retroreflected (Step 224) by the reference mirror 136. At the third fibre collimator 144, the second portion of the second light propagates through the beamsplitter 126 (Step 226) and then propagates (Step 228) through the second projection optics unit 132 and is condition by the optical elements contained therein before being focussed (Step 230) onto a point within or on the sample 134. The second light focussed on the sample 134 is specularly reflected (Step 230) and some of the reflected light returns to the second projection optics unit 132, whereupon the reflected light propagates through the second projection optics unit 132 and through the beamsplitter 126 (Step 228). Thereafter, the returning reflected light enters the second fibre collimator 144 and propagates back to the splitter 128, whereupon the returning reflected light enters the splitter 128 and is directed (Step 232) to the second optical circulator 112. At the second optical circulator 112, the returning reflected light is directed (Step 234) by the second optical circulator 112 to the first port of the balanced detector unit 116. The second optical circulator 112 serves to direct light received thereby to the third port thereof and thus the first port of the balanced detector unit 116.

Similarly, the retroreflected light from the reference mirror 136 propagates to the lens 148 and is collimated by the lens 148 prior to entering the third fibre collimator 146. Thereafter, the retroreflected light propagates to the splitter 128, whereupon the retroreflected light is directed (Step 236) by the splitter 128 towards the second port of the balanced detector unit 116 (Step 238).

The balanced detector unit 116 generates (Step 240) an interferometric signal in response to receipt of the retroreflected light originating from the reference mirror 136 and the reflected light of the first portion of the second light directed to the second fibre collimator 144 in respect of the reference arm 130 and the measurement arm 124, respectively. Thereafter, the interferometric signal is analysed in a manner described later herein.

During irradiation of the sample 134 and generation of the confocal detection signal and the interferometric signal, the translatable carriage 122 is controlled by the translation controller 137 to scan (Step 242) the lens 102 and the reference mirror 136 towards and away from the first projection optics unit 118 over a predetermined range of travel and at a predetermined frequency, thereby varying the interferometric signal and the confocal detection signal. In this regard, it should be appreciated that in this example a measurement cycle comprises a single translation or sweep in one direction of the lens 120 and the reference mirror 136 while the lens 120 and the reference mirror 136 are oscillating. However, in other embodiments the measurement cycle can comprise more than one translation.

It should be appreciated that both the confocal measurement subsystem 102 and the low-coherence interferometric measurement system 104 image longitudinally and substantially contemporaneously. In this regard, the lens 120 constitutes a longitudinal imaging component. During translation of the translatable carriage 122, the translation controller 137 receives position information in respect of the translatable carriage 122 from the position encoder (not shown).

Turning to FIG. 4, the measurement unit 139 receives the confocal signal from the confocal detector unit 114 and the interferometric signal from the balanced detector 116. The measurement unit 139 cooperates with the translation controller 137 to receive a position feedback signal obtained by the translation controller 137 from the position encoder. The measurement unit 139 uses the position feedback signal in order to sample the confocal signal and the interferometric signal.

In this regard, the interferometric signal and the confocal detection signal in combination with the position feedback signal can be used to measure simultaneously the refractive index and the thickness of the sample 124 being scanned. The measurement unit 139 receives (Step 300) the samples of the interferometric signal in order to detect (Step 302) peaks of envelopes in the time-varying interferometric signal as the translatable carriage 122 and hence the reference mirror 136 translates, the measure being in terms of pulses of the position feedback signal. When a peak is detected (Step 302), the measurement unit 139 determines (Step 304) whether this is the first of a pair of peaks being detected. In the event that the peak is the first peak being detected, the measurement unit 139 maintains (Step 306) a count of the pulses being received from the position encoder via the translation controller 137 as the translatable carriage 122 translates. The measurement unit 139 then determines (Step 308) if measurement of translation is still required. In the event that it is still necessary to determine the translation of the translatable carriage 122 between peaks detected, the measurement unit 139 continues to receive (Step 300) samples of the interferometric signal and awaits detection (Step 302) of a second peak. Upon detection of the second peak (Step 304), the measurement unit 139 calculates (Step 310) the number of pulses that have been received between peaks of envelopes of the interferometric signal constituting an interferometric measurement, A. Thereafter, the measurement unit 139 continues to measure translation of the translatable carriage 122 between detected peaks in samples of the interferometric signal (Steps 300 to 308) until such functionality is no longer required, for example when the apparatus 100 is powered down.

Likewise, the measurement unit 139 receives (Step 310) the samples of the confocal signal in order to detect (Step 312) peaks in the confocal signal, as the translatable carriage 122 and hence the lens 120 translates, the measure again being in terms of pulses of the position feedback signal. When a peak is detected (Step 312), the measurement unit 139 determines (Step 314) whether this is the first of a pair of peaks being detected. In the event that the peak is the first peak being detected, the measurement unit 139 maintains (Step 316) a count of the pulses being received from the position encoder via the translation controller 137 as the translatable carriage 122 translates. The measurement unit 139 then determines (Step 308) if measurement of translation is still required. In the event that it is still necessary to determine the translation of the translatable carriage 122 between peaks detected, the measurement unit 139 continues to receive (Step 310) samples of the confocal signal and awaits detection (Step 312) of a second peak. Upon detection of the second peak (Step 314), the measurement unit 139 calculates (Step 318) the number of pulses that have been received between peaks of the confocal signal constituting a confocal measurement, B. Thereafter, the measurement unit 139 continues to measure translation of the translatable carriage 122 between detected peaks in samples of the confocal signal (Steps 308 and 310 to 318) until such functionality is no longer required, for example when the apparatus 100 is powered down.

As noted above, low-coherence interferometric systems and confocal measurement systems employ different measures of refractive index, namely group refractive index and phase refractive index. In this regard, a confocal measurement of thickness does not give thickness, t, directly but rather t/nₚ, where nₚ is the phase refractive index. Similarly, an interferometric measurement of thickness does not give the thickness, t, directly but rather n_{g}t, where n_{g} is the group refractive index. These are defined algebraically as:

$${n}_{p} = \frac{c}{{v}_{p}} , \qquad ( 1 )$$

$$and$$

$${n}_{g} = \frac{c}{{v}_{g}} \qquad ( 2 )$$

where v_{g} and vₚ are the group and phase velocities of the light, respectively. These different refractive indices can be related by the following equation:

$${v}_{g} = ( 1 + \frac{λ}{{n}_{p}} \frac{\partial {n}_{p}}{\partial λ} ) {v}_{p} \qquad ( 3 )$$

where ∂nₚ/∂λ represents the dispersion of the medium through which the light propagates.

Substituting the expressions for nₚ and n_{g} of equations (1) and (2) into equation (3) gives the following expression relating group refractive index to the phase refractive index:

$${n}_{g} = {n}_{p} - λ \frac{\partial {n}_{p}}{\partial λ} \qquad ( 4 )$$

Given the low-coherence interferometric measurement, A, and the confocal measurement, B, and B=t/nₚ and A=n_{g}t, equation (4) can be used to relate the measurements A and B to phase refractive index, n_{g}, and wavelength, λ:

$$\frac{A}{B} = {n}_{g} {n}_{p} = {n}_{p} ( {n}_{p} - λ \frac{\partial {n}_{p}}{\partial λ} ) \qquad ( 5 )$$

Rearranging equation (5), yields:

$${n}_{p} = {[ \frac{A}{B} + \frac{{λ}^{2}}{4} {( \frac{\partial {n}_{p}}{\partial λ} )}^{2} ]}^{1 / 2} + \frac{λ}{2} \frac{\partial {n}_{p}}{\partial λ} \qquad ( 6 )$$

Having derived an expression for the phase refractive index, it follows that the thickness is given by the following expression:

$$t = ( \frac{{n}_{p} AB}{{n}_{p} - λ \frac{\partial {n}_{p}}{\partial λ}} ) \qquad ( 7 )$$

The solution of equations (6) and (7) depends upon knowledge of the dispersion. In general, this is not known, but it has been recognised that there are, for example, two situations in which certain assumptions can be made. The first is if the dispersion is very small, in which case it can be neglected. The second is if the dispersion is constant or almost constant when the refractive index changes. This is the case when the material under test is a dilute solution, in which case the refractive index changes with concentration of the solute but the dispersion remains close to that of the solvent.

This second assumption applies, for example, in relation to parts of an eye, for example an aqueous humour and a cornea. In relation to the cornea, the refractive index and thickness of the cornea are known to change in response to blood glucose concentration: the refractive index owing to the change in glucose concentration within the cornea and the thickness owing to osmosis in response to this change in glucose concentration. In such circumstances, the dispersion can be assumed to be equal or similar to that of water, and remains constant with changes in glucose concentration. This approach enables these physical changes in the cornea to be measured directly and thereby avoid inconsistency in measurements where, for example, one of refractive index or thickness can vary between separate measurements using a single technique.

In respect of this measurement cycle, during which the lens 120 and the reference mirror 136 are translated once over a predetermined translation distance, the measurement unit 139 therefore performs the confocal measurement and the low-coherence interferometric measurement. The measurement unit 139 then uses a priori knowledge of the wavelength of light employed, the dispersion being that of water and the measurements A and B from the interferometric signal and the confocal signal, in order to evaluate equation (6) to calculate the phase refractive index, np, and equation (7) to calculate the thickness of the sample 134. Such computational activity constitutes the solution of a system of equations using the first and second measurements A, B and using an assumed value of the dispersion or a value linking the two kinds of refractive index. The above process is then repeated for as many measurement cycles as required by a measurement methodology, for example if averages of the phase refractive index, nₚ, and the thickness, t, are being calculated.

From the above examples, it should be appreciated that operation of the confocal measurement subsystem 102 comprising movement of the lens 120 does not affect the interferometric measurement performed by the low-coherence interferometric measurement subsystem 104 comprising movement of the reference mirror 136. In this example, this is attributable to the fact that the scannable optical element is not disposed in the measurement arm 124 or the reference arm 130 of the low-coherence interferometric measurement subsystem 104 (or indeed the common sub-arm providing the internal optical path and formed in this example by the second projection optics unit 132). In this respect, the operation of the confocal measurement subsystem 102 does not constrain the optics of the low-coherence interferometric measurement subsystem 104 and confocal and interferometric measurements can be considered operationally independent of each other. For example, operation of the confocal measurement subsystem 102 does not influence a measurement result generated, when in use, by the interferometric measurement subsystem 104. In this respect, translation of the lens 120, for example, does not bias the interferometric measurement subsystem 104 so as to influence a measurement result generated by the interferometric measurement subsystem 104.

In any of the above examples, the optical measurement apparatus 100 can be calibrated to compensate for differences between measured distances to the sample 216. In this regard, it has been recognised that a first measurement of a distance to the sample 216 by the low-coherence interferometric measurement subsystem 104 differs from a second substantially contemporaneous measurement of the same distance to the sample 216 by the confocal measurement subsystem 102. The difference between the first and second measurements is attributable to the low-coherence interferometric measurement system 104 being linear, whereas the confocal measurement subsystem 102 possesses non-linearities. In order to be able to correct for such non-linearities in the confocal measurement subsystem 102, a dataset is compiled, in this example, to apply an error correction value to a distance measured by the confocal measurement system 102.

The dataset is compiled by providing a single-surface target opposite the measurement port 150 of the optical measurement apparatus 100 and that is translated by predetermined increments over a range of positions corresponding to the scan range of the optical measurement apparatus 100. At each incremental position, the confocal and low-coherence interferometric measurement subsystems 102, 104 measure a distance to the single-surface target. As the low-coherence interferometric measurement subsystem 104 is linear, the measurement made by the low-coherence interferometric measurement subsystem 104 is treated as a “ground truth” measurement and the difference between the pair of distances measured by the confocal measurement subsystem 102 and the low-coherence measurement subsystem 104 is calculated and constitutes the error correction value. The error correction value is stored in a lookup table with the distance measured by the confocal measurement subsystem 102.

The granularity of the dataset stored in the lookup table is initially dictated by the size of the predetermined increments of the position of the single-surface target. However, where greater resolution is required, interpolation between neighbouring values recorded in the lookup table can be calculated and stored in the lookup table. To achieve such calibration in this example, the linear encoder is configured to provide absolute distance measurements, for example through use of a reference mark therewith. As a common translatable carriage 124 is employed this technique benefits from a degree of error cancellation with respect to the measurements made by the confocal measurement subsystem 102 and the low coherence interferometric measurement subsystem 104.

Thereafter, during post-calibration normal operation of the optical measurement apparatus 100, a measurement made by the confocal measurement subsystem 102 can be looked up in the lookup table and corresponding error correction values extracted and applied by the processing resource to the measurement made.

Although in the above example a lookup table is employed, a curve fitting technique can be employed by the processing resource to fit, for example, an analytical function to the error correction values calculated. One suitable technique is a polynomial best fit technique. The fitted curve can then be referenced by the processing resource to determine an error correction value for a corresponding confocal distance measurement.

With respect to the example of an eye, it should be appreciated that the surfaces within the eye are curved and act as a lens with respect to the light emitted by confocal measurement subsystem 102. The anterior surface of the cornea provides most of the focussing power of the eye. The focussing power of the anterior surface of the cornea causes confocal signal reflected from subsequent surfaces in the eye to be displaced relative to circumstances were the anterior surface of the cornea flat. As the anterior surface of the cornea is convex, the measured apparent thickness is exaggerated, i.e. increased. This change in apparent thickness is a function of both the surface power and the distance of a given subsequent surface from the anterior surface of the cornea. If the curvature of the anterior surface of the is known, for example by measurement, the power of the anterior surface of the cornea can be calculated, and a correction factor applied to remove the effect of the surface power of the anterior surface of the cornea.

The skilled person should appreciate that the above-described implementations are merely examples of the various implementations that are conceivable within the scope of the appended claims. Indeed, in the above examples it is advantageous to make the confocal and interferometric measurements at the same wavelength for the sake of simplicity of architectural design, for example a single source of electromagnetic radiation can be employed for both subsystems. However it should be appreciated that it is possible to use different wavelengths of electromagnetic radiation for the two measurement techniques employed by the apparatus. However, in such an embodiment, dispersion is replaced by a constant relating group refractive index at a first wavelength to phase refractive index at a second wavelength. It should also be appreciated that where the source of at least partially coherent electromagnetic radiation is the SLED 106, the confocal measurement subsystem 102 can employ achromatic optics in order to ensure that no change in focal length with wavelength occurs and so the confocal point spread function is not broadened. In another embodiment, instead of achromatic optics, a narrowband filter can be employed to reduce the bandwidth of the light in this channel.

It should be appreciated that references herein to “light”, other than where expressly stated otherwise, are intended as references relating to the optical range of the electromagnetic spectrum, for example, between about 350 nm and about 2000 nm, such as between about 550 nm and about 1400 nm or between about 600 nm and about 1000 nm.

1. An optical measurement apparatus combining confocal measurement and low-coherence interferometric measurement, the apparatus comprising:
a housing;
a confocal measurement subsystem disposed within the housing;
an interferometric measurement subsystem disposed within the housing;
an optical combiner configured to provide the confocal measurement subsystem and the interferometric measurement subsystem with irradiative access to a region to be measured located at a substantially static target location; and
an optical path internal to the housing, the optical path extending from the optical combiner towards the region to be measured, the internal optical path being common to the confocal measurement subsystem and the interferometric measurement subsystem; wherein
the confocal measurement subsystem is configured to image longitudinally;
the interferometric measurement subsystem is configured to image longitudinally; and
a length of the internal optical path is fixed.

2. The apparatus according to claim 1, further comprising:
a measurement controller operably coupled to the confocal measurement subsystem and the interferometric measurement system; wherein
the measurement controller is further configured to perform, when in use, a confocal measurement and an interferometric measurement substantially contemporaneously over a measurement cycle.

3. The apparatus according to claim 1,
wherein the interferometric measurement subsystem is substantially optically uninfluenced, when in use, by operation of the confocal measurement.

4. The apparatus according to claim 1,
wherein
the confocal measurement subsystem comprises at least one longitudinal imaging component;
the interferometric measurement subsystem comprises a measurement branch and a reference branch; and
neither the measurement branch nor the reference branch of the interferometric measurement subsystem comprises the at least one longitudinal imaging component.

5. The apparatus according to claim 2, wherein the length of the internal optical path is unchanged over the measurement cycle.

6. The apparatus according to claim 1, wherein
the confocal measurement subsystem is operationally independent of the interferometric measurement subsystem.

7. The apparatus according to claim 1,
wherein the confocal measurement subsystem is operably coupled to the interferometric measurement subsystem.

8. The apparatus according to claim 1, further comprising a source of at least partially coherent electromagnetic radiation.

9. The apparatus according to claim 8, wherein the source of the at least partially coherent electromagnetic radiation is a common source of electromagnetic radiation operably shared by the confocal measurement subsystem and the interferometric measurement subsystem.

10. The apparatus according to claim 1,
wherein the confocal measurement subsystem and the interferometric subsystem are configured to use a source of electromagnetic radiation of a same wavelength.

11. The apparatus according to claim 1,
wherein the optical combiner is configured to return more light towards the confocal measurement subsystem than the interferometric measurement subsystem.

12. The apparatus according to claim 1,
wherein the confocal measurement subsystem comprises a first translatable optical element and the interferometric measurement subsystem comprises a second translatable optical element, the first and second optical elements being configured to be translated substantially contemporaneously.

13. The apparatus according to claim 12, wherein the first and second optical elements are carried by a common translatable assembly.

14. A method of rapidly measuring a refractive index and a thickness of a region to be measured located at a substantially static target location, the method comprising:
longitudinally imaging using a confocal measurement subsystem of an optical measurement apparatus to make a first measurement;
substantially contemporaneously longitudinally imaging using an interferometric measurement subsystem of the optical measurement apparatus to make a second measurement; and
calculating a thickness and a refractive index using the first and second measurements.

15. The method according to claim 14, further comprising:
solving a system of equations using the first and second measurements by neglecting a dispersion of electromagnetic radiation or assuming a constant dependent upon the dispersion of the electromagnetic radiation.
